(19) United States
(12) Patent Application Publication
(10) Pub. No.: US 2008/0205209 A1
(43) Pub. Date: Aug. 28, 2008

(54) OPTICAL DISC DEVICE

(76) Inventors: KENJI WATABE, Yokohama (JP); Ikuo Nishida, Ebina (JP); Yoichi Narui, Matsudo (JP); Masahiro Matsuo, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/858,927

(22) Filed: Sep. 21, 2007

(30) Foreign Application Priority Data
Feb. 27, 2007 (JP) 2007-047872

(51) Int. Cl. G11B 7/00

(52) U.S. Cl. 369/44.14

(57) ABSTRACT

The invention provides an optical disc device conducting highly accurate skew adjustment, avoiding an increase in the number of components, and achieving downsizing. This optical disc device includes: a guide shaft for supporting an optical pickup and guiding its movement; a chassis the guide shaft is attached to; a coil spring attached to the chassis for applying force to an end of the guide shaft; an adjustment screw for adjusting the force applied by the coil spring, provided opposite the coil spring with respect to the guide shaft; and a weight addition member attached to the chassis, wherein internal threads for engaging with the adjustment screw are formed in the weight addition member, and the axis of the adjustment screw engaged with the internal thread, the center of a cross section of the guide shaft perpendicular to its axis, and the axis of the coil spring are aligned along the same line.

### CROSS-REFERENCES TO RELATED APPLICATIONS

This application relates to and claims priority from Japanese Patent Application No. 2007-47872, filed on Feb. 27, 2007 the entire disclosure of which is incorporated herein by reference.

### BACKGROUND

1. Field of the Invention

The invention relates generally to an optical disc device having a skew adjustment mechanism for adjusting the inclination of a guide shaft that supports an optical pickup and guides the movement of the optical pickup.

2. Description of Related Art

In optical disc devices, in particular ones for Blu-ray Discs, highly accurate tilt adjustment has conventionally been required. Optical disc devices have a skew adjustment mechanism for adjusting an optical pickup by inclining a guide shaft that supports the optical pickup so that light emitted from or entering the optical pickup can exit/enter at a right angle with respect to the disc surface. Examples of that kind of skew adjustment mechanism include one that grasps the guide shaft with an elastic body and an adjustment screw and adjusts the inclination of the guide shaft by the amount the adjustment screw is turned (for example, see Japanese Patent Laid-Open (Kokai) Publication No. 2004-355771, Japanese Patent Laid-Open (Kokai) Publication No. 2004-234798, Japanese Patent Laid-Open (Kokai) Publication No. 11-238232, and International Publication No. 01/97222).

The above described conventional skew adjustment mechanism has a configuration including an end of a guide shaft, a bracket that contains an elastic body and an adjustment screw that grasps the end of the guide shaft, and an adjustment screw receiving plate put on the upper (or lower) surface of the bracket and having an internal thread engaged with the adjustment screw, with the bracket and the adjustment screw receiving plate being fixed to a chassis, or the internal thread that can engage with the adjustment screw being formed on the chassis. However, a skew adjustment mechanism having an adjustment screw receiving plate fixed to a chassis needs a separate adjustment screw receiving plate in addition to regularly used parts, and accordingly, the number of parts required increases.

Moreover, the skew adjustment mechanism has to move the adjustment screw in the direction of its axis to change the inclination of the guide shaft. Therefore, in a skew adjustment mechanism with a chassis having an internal thread formed thereon, the chassis needs to have a thickness for maintaining the moving distance (screwing distance) necessary for the adjustment screw to move.

### SUMMARY

The present invention has been made in light of the circumstances described above, and its object is to provide an optical disc capable of not only conducting highly accurate skew adjustment, but also avoiding an increase in the number of parts, and achieving downsizing.

To achieve the above object, the invention provides an optical disc device for at least either recording or reproducing, using an optical pickup, a signal on/from an information recording side of an optical disc, the optical disc device including: a guide shaft for supporting the optical pickup and guiding the movement of the optical pickup; a chassis to which the guide shaft is attached to; a force-applying member attached to the chassis for applying force to an end of the guide shaft in a direction generally perpendicular to an axial direction of the guide shaft; an adjustment screw for adjusting the force applied by the force-applying member, that is locate on one side of the guide shaft opposite the side where the force-applying member is located; and a weight addition member attached to the chassis for adding weight to the chassis. In the above described optical disc device, an internal thread for engaging with the adjustment screw is formed in the weight addition member. The axis of the adjustment screw engaging with the internal thread, the center of a cross section of the guide shaft perpendicular to its axis, and the central line of the force-applying member parallel to its force-applying direction are aligned along the same line.

Since the axis of the adjustment screw, the center of a cross section of the guide shaft perpendicular to its axis, and the central line of the force-applying member parallel to its force-applying direction are aligned along the same line, no moment works on the guide shaft. Accordingly, no unnecessary load is applied to the guide shaft, and accordingly, highly accurate skew adjustment can take place. Moreover, since an internal thread for engaging with the adjustment screw is formed in the weight addition member for adding weight to the chassis, no additional separate member with such an internal thread to be engaged with the adjustment screw is necessary. Accordingly, an increase in the number of parts can be avoided, and downsizing of the optical disc device can be achieved.

Other aspects and advantages of the invention will be apparent from the following description and the appended claims.

### BRIEF DESCRIPTION OF THE DRAWINGS

FIG. 1 is a perspective view of an embodiment of the optical disc device of the invention.

FIG. 2 is a perspective view of the configuration of main components of the optical disc device shown in FIG. 1.

FIG. 3 is an exploded perspective view of the optical disc device shown in FIG. 1.

FIG. 4 is a perspective view of a chassis a pickup is attached to via a guide shaft.

FIG. 5 is a cross sectional view along the line V-V shown in FIG. 4.

FIG. 6 is an exploded view taken along the line VI-VI shown in FIG. 2.

FIG. 7 is a cross sectional view along the line VII-VII shown in FIG. 4.

FIG. 8 is a view enlarging a part of FIG. 7.

FIG. 9 is a view enlarging a part of FIG. 6.

FIG. 10 is a view enlarging a cross section along the line X-X shown in FIG. 4.

### DETAILED DESCRIPTION OF PREFERRED EMBODIMENTS

A preferred embodiment of the optical disc device of the invention will be described below with reference to the drawings. The embodiment described below is just an example for explanation of the invention, and the invention is not limited to this embodiment. Accordingly, the invention can be implemented in various modes without departing from the scope of the invention.

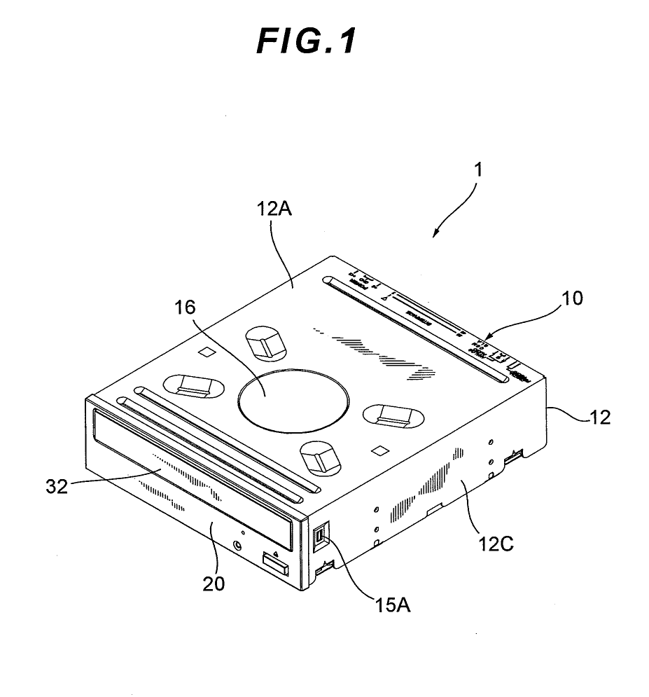

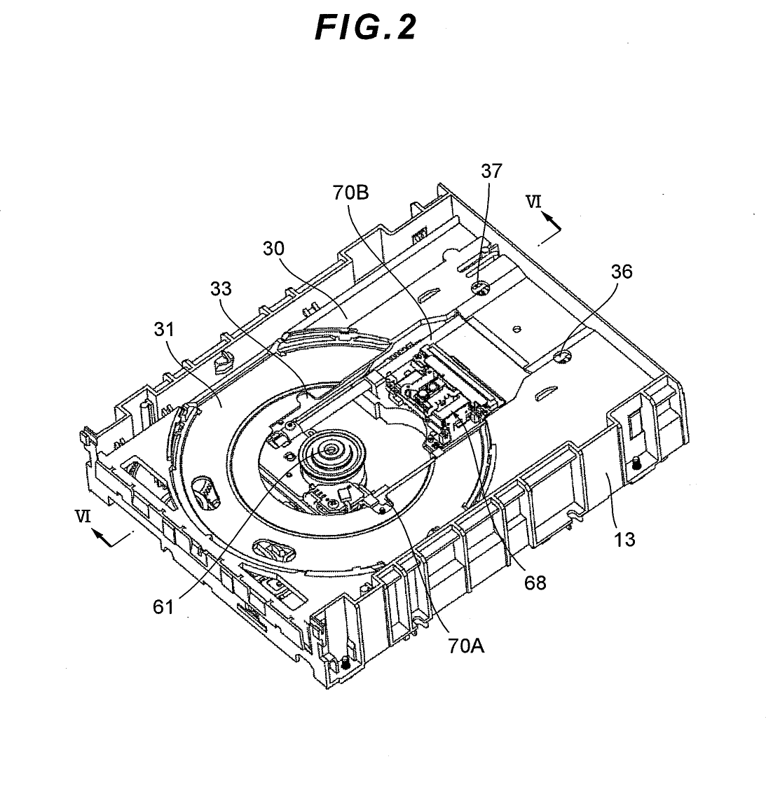

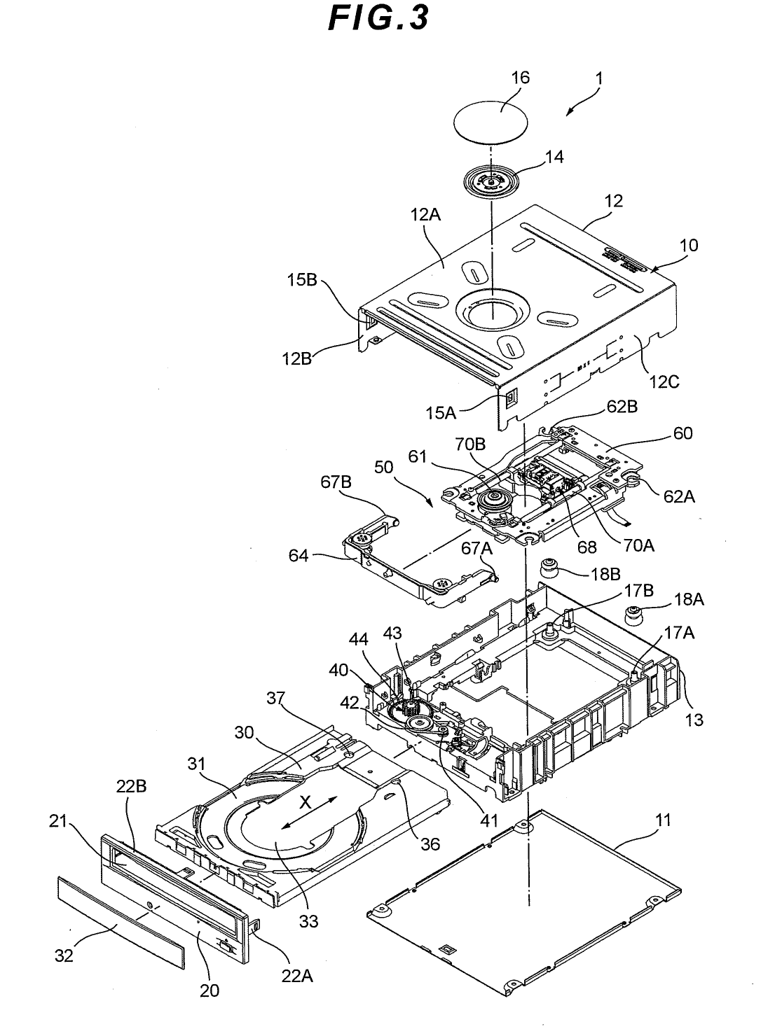

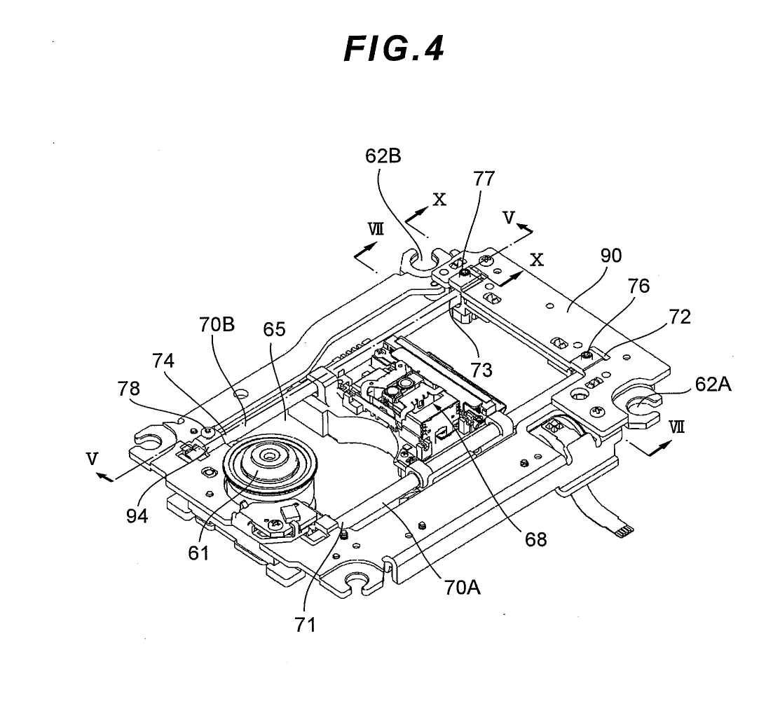

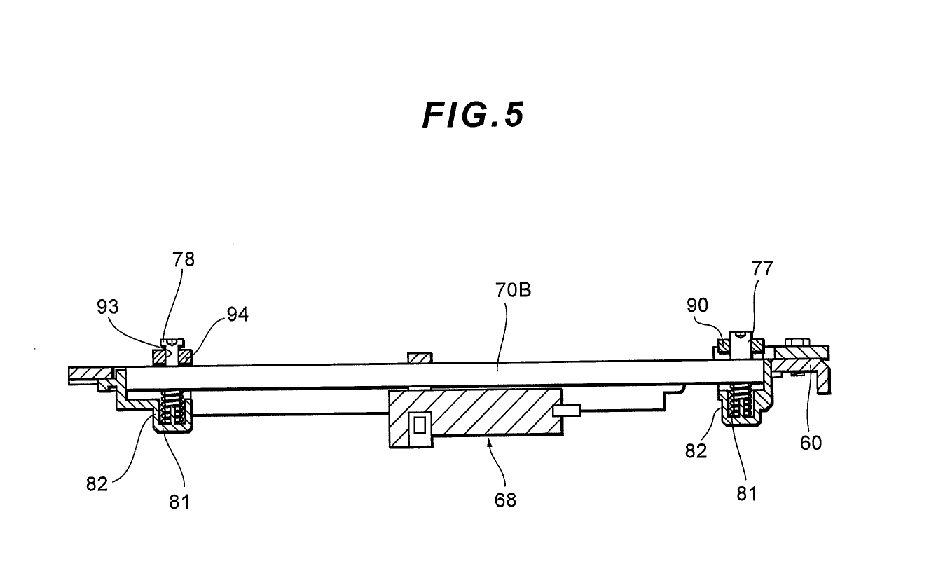

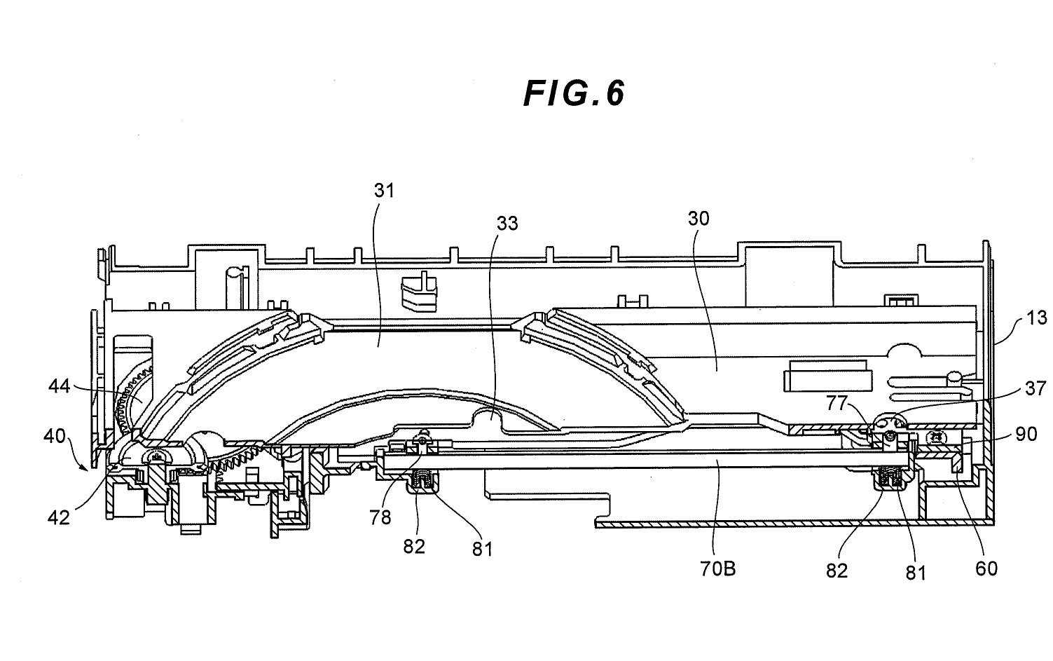

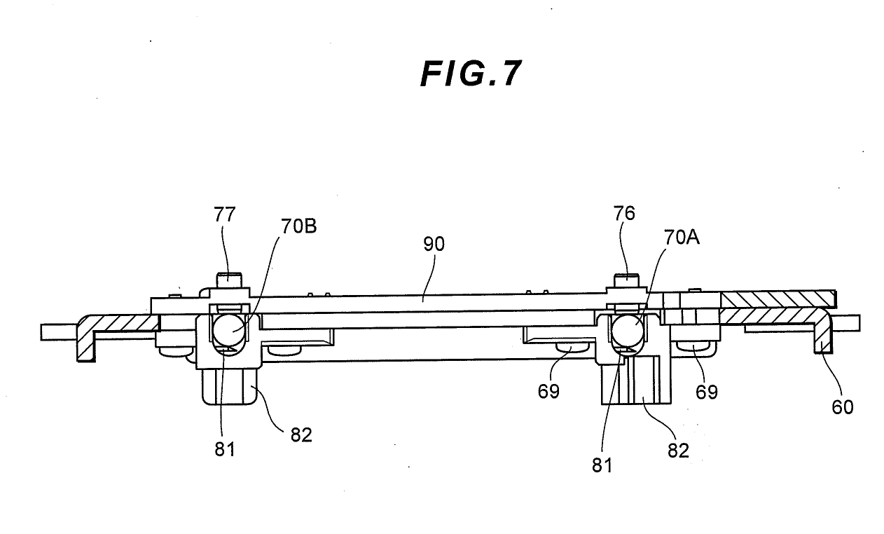

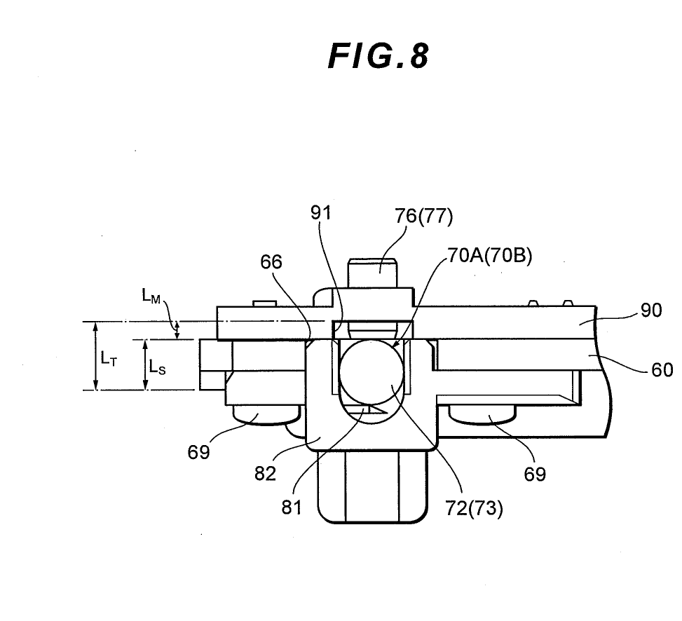

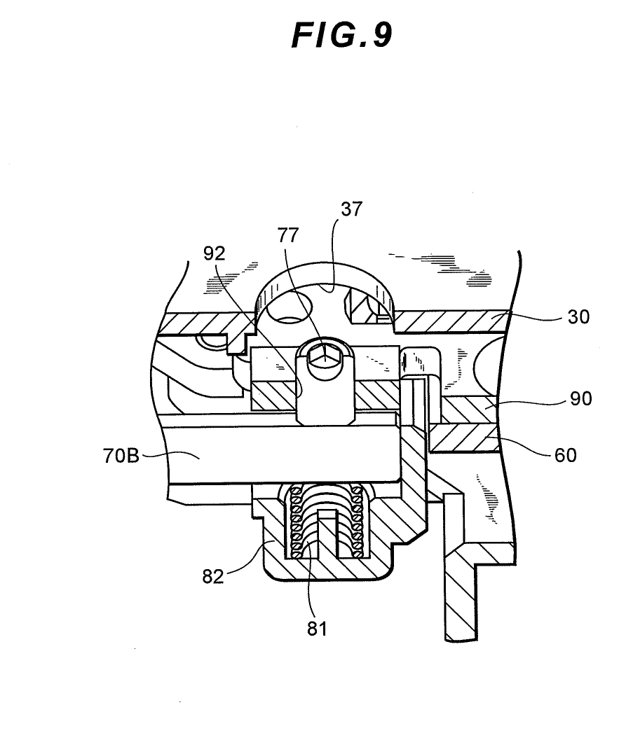

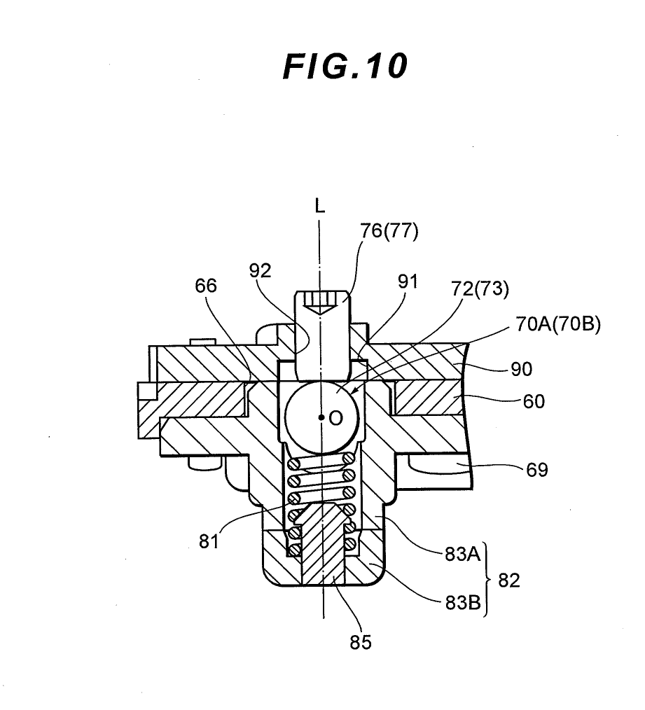

FIG. 1 is a perspective view of the embodiment of the optical device of the invention. FIG. 2 is a perspective view of the configuration of the main components in the optical disc device shown in FIG. 1. FIG. 3 is an exploded perspective view of the optical disc device shown in FIG. 1. FIG. 4 is a perspective view of a chassis a pickup is attached to via a guide shaft. FIG. 5 is a cross sectional view along the line V-V shown in FIG. 4. FIG. 6 is an exploded view taken along the line VI-VI shown in FIG. 2. FIG. 7 is a cross sectional view along the line VII-VII shown in FIG. 4. FIG. 8 is a view enlarging a part of FIG. 7. FIG. 9 is a view enlarging a part of FIG. 6. FIG. 10 is a view enlarging a cross section along the line X-X shown in FIG. 4.

For ease of explanation, in the drawings, the thickness, size and scale ratio, etc. are not the same as in the real components. In the explanation of this embodiment, the “front side” is the side of an optical disc insertion/ejection slot, and the “back side” is the opposite side.

As shown in FIGS. 1-10, the optical disc 1 of this embodiment includes a box-shaped case 10 that contains a processing mechanism 50 for executing recording/reproduction processing on an optical disc; a front bezel 20 for covering the front open end of the case 10; and a tray 30 for inserting/ejecting an optical disc into/from the processing mechanism 50.

The main components of the processing mechanism 50 include a recording/reproduction mechanism centered around an optical pickup 68, and an optical disc driving mechanism for carrying/ejecting an optical disc to/from the recording/reproduction mechanism.

The case 10 includes a base 11, a metallic cover 12 formed by integrally molding a top plate 12A and side plates 12B and 12C, and a mechanism base 13 the processing mechanism 50 is fixed to, contained in the space between the base 11 and the cover 12. On the back side of the top plate 12, a turntable 61 installed in a chassis 60, which will be described later in detail, attached to the mechanism base 13, and a disc clamp 14 for grasping an optical disc are placed. Reference numeral 16 represents a cover for covering the disc clamp 14.

The mechanism base 13 has cylindrical members 17A and 17B on both sides of its back end, which are inserted respectively into attachment holes 62A and 62B formed in the chassis 60, which will be described later in detail. The cylindrical members 17A and 17B are also inserted into bushes 18A and 18B respectively. The bushes 18A and 18B, which will also be described later in detail, are members for assisting swinging movement of the chassis 60.

The front bezel 20 has an opening 21 via which the tray 30, which will also be described later in detail, is inserted into/ejected from the case 10. Strip-shaped pieces 22A and 22B each protruding towards the case 10 are provided at both the left and right ends of the front bezel 20. The tips of the pieces 22A and 22B are provided with nails 23A and 23B respectively for engaging with apertures 15A and 15B formed in the side plates 12B and 12C near the front bezel 20. The front bezel 20 is attached to the chassis 20 by engaging the nails 23A and 23B with the apertures 15A and 15B respectively.

The tray 30 moves, via the opening 21 in the front bezel 20, towards/away from the processing mechanism 50 contained in the case 10 in the direction along the arrow X shown in FIG. 3. The tray 30 is moved back and forth by a tray driver 40 that is a component of the above described optical disc driving mechanism and is provided at the front end of the mechanism base 13. The tray 30 has a plate 31 an optical disc is put on, and a front panel 32 that covers the opening 21 in the front bezel 20. Numerical reference 33 represents an opening formed in the plate 31.

As described later in detail, the tray 30 has through holes 36 and 37 for receiving, when the tray 30 enters the case 10 and the chassis 60 swings in the direction approaching the optical disc put on the plate 31 in the tray 30, adjustment screws 76 and 77 for skew adjustment provided in the chassis 60, the holes 36 and 37 being provided at the position facing the adjustment screws 76 and 77. The holes 36 and 37 are formed to avoid interference between the tray 30 that is entering the case 10 and the adjustment screws 76 and 77 in the chassis 60 that is swinging in the direction approaching the optical disc.

The tray driver 40 is rotated by a first pulley 41 attached to a rotary shaft of a motor (not shown), a second pulley 42 the rotation of the first pulley 41 is transmitted to via a belt, an intermediate gear 43 rotated by the second pulley 42, and a pinion 44 rotated by the intermediate gear 43 and engages with a rack (not shown) formed in the tray 30. Accordingly, the tray 30 is moved towards/away from the above described recording/reproduction mechanism by an electronic circuit (not shown) controlling the rotative direction of the motor.

The chassis 60 provided with the above described recording/reproduction mechanism is attached to the mechanism base 13 at a position closer to the base 11 than the position where the tray 30 is inserted. The turntable 61 that supports an optical disc to enable the disc to rotate is provided at the front end of the chassis 60. The optical disc is chucked between the turntable 61 and the disc clamp 14 provided on the back side of the top plate 12A.

The attachment holes 62A and 62B are formed respectively at the left and right sides of the back end of the chassis 60, and the cylindrical members 17A and 17B provided in the mechanism base 13 are inserted into those attachment holes 62A and 62B respectively. The cylindrical members 17A and 17B inserted into the bushes 18A and 18B are then inserted into the chassis 60, and the chassis 60 can swing, around the cylindrical members 17A and 17B that act as swing fulcrums, towards/away from the optical disc put on the plate 31 in the tray 30.

A swing member 64 for swinging the chassis 60 is attached to the front end of the chassis 60. The swing member 64 is generally C-shaped. Shafts 67A and 67B for attaching the swing member 64 to the sidewall of the mechanism base 13 to enable swinging movement of the swing member 64 are provided on the outside of both ends of the swing member 64. When the tray 30 enters the case 10 and arrives at a predetermined position, the swing member 64 swings around the shafts 67A and 67B, which act as swing fulcrums, in the direction approaching the tray 30. When the tray 30 is ejected, the swing member 64 swings around the shafts 67A and 67B in the direction away from the tray 30. With that movement, the chassis 60 the swing member 64 is attached to also swings in the same way around its back end where the attachment holes 62A and 62B the cylindrical members 17A and 17B are inserted into are provided. When the chassis 60 swings in the direction approaching the tray 30, the force that brings the back end of the chassis 60 closer to the base 11 is applied to the bushes 18A and 18B, and the bushes 18A and 18B elastically change their shape and are compressed Meanwhile, when the chassis 60 swings in the direction away from the tray 30, the bushes 18A and 18B are released from that force and return to their original shape, applying force to the chassis 60 to the cover 12 side due to the force resulting from its elastic tendency to regain its original shape.

After an optical disc is put on the plate 31 and the tray 30 enters the case 10, the chassis 60 swings in the direction approaching the tray 30 and the turntable 61 moves upwards beyond the opening 33 and lifts the optical disc put on the tray 30. Next, the disc clamp 14 on the back side of the top plate 12A fixes the optical disc to the turntable 61 to enable the optical disc to rotate.

An opening 65 for receiving the above described recording/reproduction mechanism is formed at the approximate center of the chassis 60. The guide shafts 70A and 70B for supporting the optical pickup 68 and guiding the movement of the optical pickup 68 are provided respectively at left and right sides of the opening 65. The front end 71 of the guide shaft 70A is fixed to the chassis 60 so that the guide shaft 70A can swing around the front end 71 that acts as a swing fulcrum. Meanwhile, as shown in FIGS. 8-10 in particular detail, a bracket 82 that receives the back end 72 of the guide shaft 70A and a coil spring 81 that applies force to the back end 72 in a direction generally perpendicular to the direction of the axis of the guide shaft 70A is provided to the chassis 60 at the position where the back end 72 of the guide shaft 70A is placed. The bracket 82 includes a bracket body 83A having space for receiving the back end 72 of the guide shaft 70A and the coil spring 81, and a cover 83B for covering the internal space in the bracket body 83A.

The internal space formed in the bracket body 83A has an internal diameter slightly larger than the external diameter of the coil spring 81 so that the coil spring 81 can maintain its posture and elastically change the shape in the direction of the axis of the coil spring 81. The end of the bracket body 83A opposite the end where the cover 83B is provided is inserted into a through hole 66 formed in the chassis 60. The bracket 82 is fixed to the chassis 60 with a screw 69.

The cover 83B has a hook 85 for engaging with the coil spring 81 to lock the coil spring 81 to the cover 83B, and the hook 85 protrudes towards the bracket body 83A. The hook 85 can prevent the coil spring 81 from being lost during the assembly process, and can also prevent the coil spring 81 from falling down when putting the cover 83B over the bracket body 83A and assembling the bracket 82. As shown particularly in FIG. 10, the coil spring 81 is provided so that the center O of the cross section of the guide shaft 70A taken along its diameter and the central line (axis) of the coil spring 81 are aligned along the same line.

The chassis 60 has similar brackets 82 also at the positions where the back end 73 and the front end 74 of the guide shaft 70B are placed. The bracket 82 provided at the position where the back end 73 of the guide shaft 70B is placed similarly receives the back end 73 and the coil spring 81, and the bracket 82 provided at the position where the front end 74 of the guide shaft 70B is placed similarly receives the front end 74 and the coil spring 81.

A weight addition member (weight member) 90 for adding weight to the chassis 60 is provided in the portion at the back end of the chassis 60 including the area where two through holes 66 are formed. In the portion of the weight addition member 90 facing the through holes 66, a first hole 91 having generally the same diameter as the through hole 66, and an internal thread 92 communicating with the first hole 91 and having a diameter smaller than the diameter of the first hole 91 are formed in this order from the chassis 60 side. The internal thread 92 is provided so that when the internal thread 92 engages with the adjustment screw 76 (77) for skew adjustment, the center O of the cross section of the guide shaft 70A (70B) taken along its diameter, the center line (axis) of the coil spring 81, and the axis of the adjustment screw 76 (77) are aligned along the same line, as shown in particular in FIG. 10. The adjustment screw 76 (77) is in contact with the back end 72 (73) of the guide shaft 70A (70B), and enters, when turned in the tightening direction, the internal space in the bracket 82 through the first hole 91 to press the back end 72 (73) of the guide shaft 70A (70B) towards the base 11 side against the force applied by the coil spring 81. Meanwhile, when the adjustment screw 76 (77) is turned in the untightening direction (the reverse of the tightening direction), the back end 72 (73) is pressed and swings (moves) towards the top plate 12A due to the force applied by the coil spring 81. At this moment, the back end 72 (73) can also proceed further into the first hole 91 formed in the weight addition member 90. With that movement, the force applied by the coil spring 81 is adjusted and the inclination of the guide shaft 70A (70B) is changed.

In order to change the inclination of the guide shaft 70A (70B) by turning the adjustment screw 76 (77) engaging with the internal thread 92 clockwise or counterclockwise (tightening direction or untightening direction) and moving the adjustment screw 76 (77) towards/away from the guide shaft 70A (70B), a predetermined movement distance (screw length) in the direction of its axis needs to be kept for the adjustment screw 76 (77). For example, in the example shown in FIG. 8, the moving distance (L_{T}) of the adjustment screw 76 (77) is longer than the thickness (Lₛ) of the chassis 60. Therefore, it is necessary to make the thickness (Lₛ) of the relevant portion of the chassis 60 thicker, or provide an additional part to maintain the moving distance. Since the necessary moving distance (L_{T}) considerably exceeds the thickness (Lₛ) of the chassis 60, it is difficult to employ the former measure using press treatment or similar methods. Meanwhile, in the latter case, a separate additional member needs to be prepared, which involves a lot of trouble, and increases the number of parts. The present invention uses the weight addition member 90 usually provided to the chassis 60 to add weight to the chassis 60 and control the swing movement of the chassis 60. The moving distance (L_{T}) is maintained by installing the above described weight addition member 90 in the area where the moving distance (L_{T}) of the adjustment screw 76 (77) has to be maintained and forming the internal thread 92 in the weight addition member 90. Accordingly, the chassis 60 can be manufactured using regular press working or similar, without the need for separately preparing any additional member. Reference character LM shown in FIG. 8 represents the adjustment margin for the adjustment screw 76 (77).

A concave portion 94 for forming the internal thread 92 for engaging with the adjustment screw 78 for skew adjustment is formed in the chassis 60 at the position where the front end 74 of the guide shaft 70B is placed. The adjustment screw 78 is also provided there, in the same way as the above described adjustment screws 76 and 77, so that the center O of the cross section of the guide shaft 70B taken along its diameter, the center line (axis) of the coil spring 81, and the axis of the adjustment screw 78 are aligned along the same line. This adjustment screw 76 also changes the inclination of the guide shaft 70B by adjusting the force applied by the coil spring 81, as the adjustment screws 76 and 77 do so.

The upper portion of the adjustment screw 76 (77) may protrude beyond the upper surface of the chassis 60, depending on the degree of skew adjustment for the guide shaft 70A or 70B, as shown in particular in FIGS. 8-10. Even in that case, the adjustment screw 76 (77) enters the hole 36 (37) formed in the tray 30 when the tray 30 enters the case 10, and accordingly, the tray 30 does not interfere with the adjustment screw 76 (77).

The optical pickup 68, which functions as an optical unit, is attached to the guide shafts 70A and 70B so that the optical pickup 68 can move. This optical pickup 68, facing the recording side of an optical disc interposing the opening 65 formed in the chassis 6, moves along the guide shafts 70A and 70B and projects laser light onto the optical disc put on the plate 31 of the tray 30. In other words, the optical pickup 68 moves along the disc's radius from an initial information recording position on the inner circumferential side of the disc to the outer circumferential side. When doing so, the distance between the information recording side of the optical disc and the optical pickup 68 has to be constantly kept at a predetermined length, regardless of the position of the optical pickup 68. To this end, skew adjustment is executed using the coil springs 81 and the adjustment screws 76, 77, and 78 to optimize the inclination of the guide shafts 70A and 70B.

During skew adjustment, the adjustment screw 76 is rotated at first to swing, by a predetermined amount, the back end 72 of the guide shaft 70A around the front end 71 that acts as a swing fulcrum, and the inclination of the guide shaft 70A is adjusted. Next, the adjustment screw 77 (78) is turned to adjust the inclination of the guide shaft 70B and its level relative to the guide shaft 70A. That adjustment process is conducted based on values predetermined for each device.

A circuit board (not shown) is provided between the base 11 and the mechanism base 13. The circuit board includes electronic components respectively for controlling the turntable 61's rotation, controlling the driving system 40 for the tray 30, and controlling the movement of the optical pickup 68 and the recording/reproduction.

The above embodiment has been explained for the case where the holes 36 and 37 are formed for the purpose of avoiding the interference between the tray 30 and the adjustment screws 76 and 77. However, the invention is not limited to that, and concave portions, instead of the holes 36 and 37, may be formed if the interference between the tray 30 and the adjustment screws 76 and 77 can be avoided.

Also, the above embodiment has been explained for the case where the hook 85 that functions as a locking member for locking the coil spring 81 is provided in the cover 83B. However, the invention is not limited to that, and another type of locking member may be provided if the member can engage with and lock the coil spring 81.

Also, the above embodiment has been explained for the case using the coil spring 81 as a force-applying member. However, the invention is not limited to that, and the force-applying member may be arbitrarily selected from elastic members such as a spiral spring, coned disc spring, and rubber, etc., if force can be applied to the guide shafts 70A and 70B according to the degree of engagement between the adjustment screws 76-78 and the internal threads 92.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. An optical disc device for at least either recording or reproducing, using an optical pickup, a signal on/from an information recording side of an optical disc, the optical disc device comprising:
a guide shaft for supporting the optical pickup and guiding the movement of the optical pickup;
a chassis to which the guide shaft is attached;
a force-applying member attached to the chassis for applying force to an end of the guide shaft in a direction generally perpendicular to an axial direction of the guide shaft;
an adjustment screw for adjusting the force applied by the force-applying member, that is located on one side of the guide shaft opposite the side where the force-applying member is located; and
a weight addition member attached to the chassis for adding weight to the chassis,
wherein an internal thread for engaging with the adjustment screw is formed in the weight addition member, and the axis of the adjustment screw engaging with the internal thread, the center of a cross section of the guide shaft perpendicular to its axis, and the central line of the force-applying member parallel to its force-applying direction are aligned along the same line.

2. The optical disc device according to claim 1 further comprising a tray for placing the optical disc and carrying the optical disc to a recording/reproduction position where the signal is recorded and/or reproduced, wherein the tray has a recess capable of receiving the adjustment screw when the optical disc is carried to the recording/reproduction position.

3. The optical disc device according to claim 1, wherein a bracket for receiving the force-applying member is provided in the chassis, and a locking member for engaging with and thereby locking the force-applying member is provided on the bracket.

4. The optical disc device according to claim 1 comprising first and second guide shafts, spaced apart from each other and arranged generally in parallel with each other;
wherein the first guide shaft is secured to the chassis so that the first guide shaft can swing around one of its ends that acts as a swing fulcrum, and the other end is held between the force-applying member and the adjustment screw;
wherein both ends of the second guide shaft is held between the force-applying member and the adjustment screw; and
wherein the weight addition member is attached to an area where the other end of the first guide shaft and one end of the second guide shaft, which is located opposite the other end of the first guide shaft, are placed.

5. The optical disc device according to claim 3, wherein the bracket includes: a bracket body having an internal space that receives an end of the guide shaft and the force-applying member and is connected to the internal thread, and in which the adjustment screw engaging with the internal thread can move back and force a cover for closing the internal space the cover provided at an end of the bracket body on the side where the force-applying member is placed, wherein the locking member is placed on the cover.
